(19) United States
(12) Patent Application Publication
(10) Pub. No.: US 2006/0143183 A1
(43) Pub. Date: Jun. 29, 2006

(54) System and method for providing collection sub-groups

(76) Inventors: Adam Jason Goldberg, East Hills, NY (US); Wayne Hsing-Yuan Ting, New York, NY (US)

Correspondence Address: HOWARD C. MISKIN;C/O STOLL, MISKIN, & BADIE, THE EMPIRE STATE BUILDING, 350 FIFTH AVENUE SUITE 4710, NEW YORK, NY, 10118, US

(21) Appl. No.: 11/022,463

(22) Filed: Dec. 23, 2004

(51) Int. Cl. G06F 17/30

(52) U.S. Cl. 707/10

(57) ABSTRACT

A system and method, as well as a computer-readable medium, are disclosed for providing collection subgroups within a main website that enable and facilitate networking for people having specific common interests or characteristics. Personal information provided by a user determines the user's automatic inclusion into a specific collection/category website. Computer generated routines supplied by the computer-readable medium of the present invention automatically fits users into one or more collections based on self-constructed concepts. In one embodiment, the present invention groups users into at least one collection and allow dynamic social-networking without the need for a user to pursue other's profiles to identify common interests or characteristics.

### FIELD OF THE INVENTION

The invention relates generally to a system and method of operation thereof that enable and facilitate online communities and, more particularly, to a system and method of operation thereof that enable and facilitate online communities, such as social-networking for people having specific common interests or characteristics, while still allowing for traditional networking associated with online communities.

### BACKGROUND OF THE INVENTION

Systems and methods of operation thereof for social-networking provide processes of connecting individuals, via friends, relatives, and acquaintances—a user's “personal network” through the use of the Internet. A participant in social-networking can branch out of his/her “personal network” and connect with friends of friends within a predetermined accepted social circle. Each degree of separation would expand the “network” within which user interactions are allowed—some communities allow six degrees of separation from the user's “personal network,” while other communities allow the user to individually determine the expansiveness of their personal network.

In addition to a user's “personal network,” social-networking sites may also facilitate social interaction, via functions such as user journal, photo gallery, news, messaging, file sharing, dating, and other mediums of social/idea exchange. Such features offer users the means to individualize their personals pages, to exchange messages, and to showcase artistic and intellectual expressions. These features also offer users a more in depth look into another user's personality, interests, and ideology, increasing the potential for meaningful connections between users.

The advantage of social networking derives from the argument that online exchanges vis-a-vis friends of friends are more safe and substantive than traditional online interactions. Users often use such networks to meet friends, build business relationships, keep in touch with former classmates, or simply browse through other user's personal pages. As such, social-networking websites have expanded the traditional role of online communities. Traditional online communities provide users with similar functionality's, minus the concept of a user's “personal network”.

The current trend in online communities has seen the rise of increasingly specialized websites targeted for specific groups of people (e.g., college students, African Americans, homosexuals, etc.). This trend reflects the way people interact in everyday life—often with people who exhibit similar interests, live comparable lifestyles, and/or have the same background. These specified online communities attract users who desire to interact with only a specified group of people.

In the long run, however, this trend may prove problematic as sites become increasingly specialized, limiting the amount of people who are willing to become members, and therefore, stifling the potential social interactions. Furthermore, though specialized sites reflect users' desire to meet people of certain characteristics, they do not reflect the potential desire by these same users to meet people of other characteristics as well. Lastly, though users may want to meet people of a certain characteristic, it does not mean that these users do not want to interact with people of all backgrounds in a generic online community with no limitation to membership. As a result, specified online communities often force users to join additional online communities—either generic or specified. These users end up with multiple accounts on a variety of non-compatible online communities in order to fulfill all of the users' needs and interests. It is desired to eliminate these drawbacks by offering users the same functionality of a specified social-networking site, while also providing access and reach to people of all other backgrounds and interests.

### OBJECTS OF THE INVENTION

Accordingly, it is an object of the present invention to provide a system and method of operation thereof that enable and facilitate online communities, such as social-networking for people having specific common interests or characteristics, while also still providing access and reach to people of all other backgrounds and interests.

It is an object of the present invention to provide a system and method of operation thereof that provide online communities to be grouped and re-grouped by themselves, based on any criteria determined by the individual user, allowing the user to join one site that fulfills all of his/her interests. In this manner, the system and method of operation thereof truly reflect the manner people interact in everyday life by enabling social interaction between people of similar interests and backgrounds, while also enabling interactions between people of different interests and backgrounds, and at the same time, enabling interactions between people of all interests and backgrounds.

### SUMMARY OF THE INVENTION

The invention is directed to a system and method of operation thereof, as well as a computer-readable medium having computer-readable instructions thereon, that enable and facilitate a website to provide social-networking for people having common interests or characteristics, while still providing access and reach to people of all backgrounds and interest.

The system comprises a website having a center for receiving information from at least one member of the website. The member provides self-identified characteristics to the center of the website. The website has a database providing a collection based on the member's self-identified characteristics. The website also has means so as to allow the member to select a collection.

The method comprises the steps of: a) providing a website having a center for receiving information; b) providing at least one member of the website; c) the at least one member providing self-identified characteristics to the center of the website; d) the website providing at least one collection based on the member's self-identified characteristics; and e) the member selecting one of the collections.

The computer-readable medium has thereon computer-readable instructions comprising: providing the website with the capability to receiving information from at least one of the members of the website and which information being indicative of self-identified characteristics of the member; providing the website with at least one collection based on the members self-identified characteristics; presenting the at least one collection so as to be selectable by the member; and providing the networking for people having common interests or characteristics in response to the selection by the member.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram illustrating an exemplary network environment for communications involved with an embodiment of the invention;

FIG. 2 is a flow chart for the method of operation of the present invention; and

FIG. 3 is a flow chart illustrating further details of the method of operation of FIG. 2.

FIG. 4 shows an example of a database having three separate tables.

FIG. 5 shows an example of a grouping by the collection mechanism of the present invention.

### DETAILED DESCRIPTION OF THE INVENTION

Turning to the drawings, wherein like reference numerals refer to like elements, the invention is described hereinafter in the context of a computing environment. Although it is not required for practicing the invention, the invention is described as it is implemented by computer-executable instructions contained on a computer-readable medium, such as program modules, that are executed by a computing device. Generally, the computer-readable instructions of the computer-readable medium include routines, programs, objects, components, data structures and the like that perform particular tasks or implement particular abstract data types.

The invention may be implemented in many different computing device configurations. For example, the invention may be realized in hand-held devices, mobile phones, multi-processor systems, microprocessor-based or programmable consumer electronics, network PCs, mini-computers, mainframe computers and the like, wearable computing or communication devices, and any other device capable of both visual display and direct or indirect communication with another device. The invention may also be practiced in distributed computing environments, where tasks are performed by remote processing devices that are linked through a communications network. In a distributed computing environment, program modules may be located in both local and remote memory storage devices. Thus, it will be understood that the invention is preferably incorporated into many types of computing environments as suggested above.

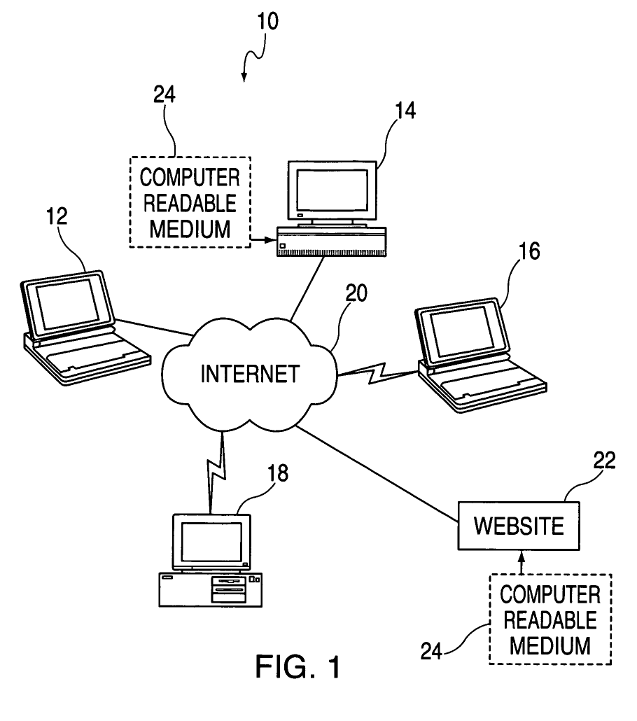

In the description that follows, the invention will be described with reference to acts and symbolic representations of operations that are performed by one or more computing devices, unless indicated otherwise. As such, it will be understood that such acts and operations, which are at times referred to as being computer-executed, include the manipulation by the processing unit of the computing device of electrical signals representing data in a structured form. This manipulation is also applicable with websites that are in operative cooperation with associated computing devices. This manipulation transforms the data or maintains it at locations in the memory system of the computing device, which reconfigures or otherwise alters the operation of the computing device in a manner well understood by those skilled in the art. The data structures where data is maintained are physical locations of the memory that have particular properties defined by the format of the data. However, while the invention is being described in the foregoing context, it is not meant to be limiting as those of skilled in the art will appreciate that various of the acts and operations described hereinafter may also be implemented in hardware. The invention may be further described with reference to FIG. 1.

FIG. 1 is a schematic diagram of a network environment 10 within which an embodiment of the invention may be implemented. In particular, a plurality of computing devices 12, 14, 16, and 18 are illustrated as being communicably linked via a network, such as, the Internet 20 which, in turn, is communicably linked to a website 22 having a center for receiving information. The center serves as a centralized location receiving information and performing the processing for the website 22. The present invention is applicable to online communities, but is particularly applied to social-networking website 22 and to traditional online community website 22, where people come together in search of substantive interactions, via the World Wide Web. However, the invention is also applicable to weblog sites, online directory sites, dating sites and any other form of online communities that user may use as a means to meet others.

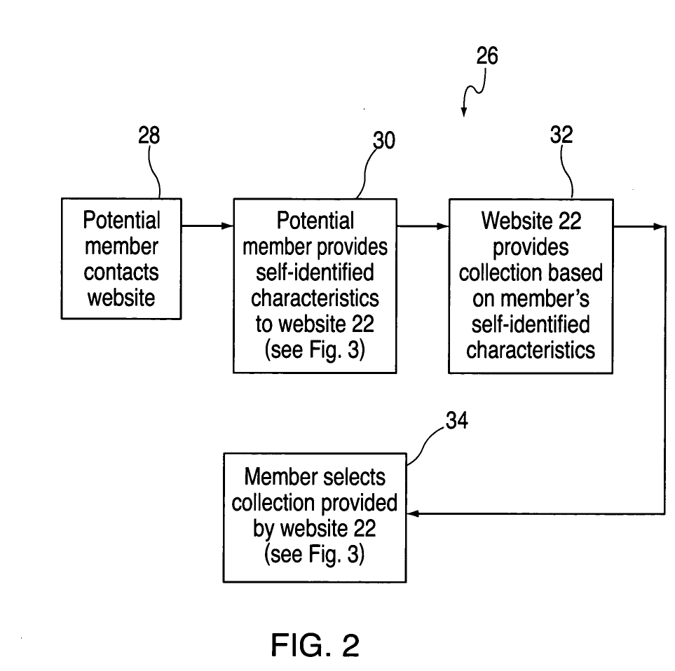

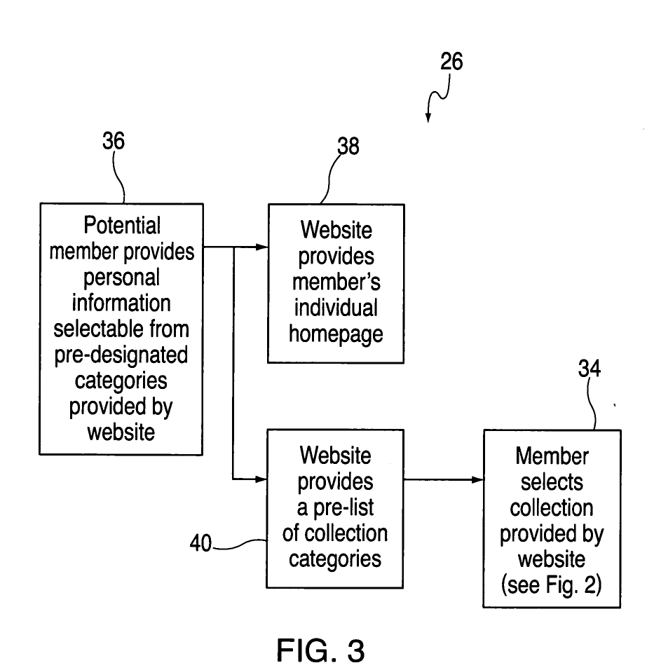

In general, the present invention provides a system 10 and method of operating thereof, to be further described with reference to FIGS. 2 and 3, for enabling social-networking providers 12, 14, 16 or 18, or traditional online communities 12, 14, 16 or 18, using a computer network such as the Internet 20, to group users into restricted “collections” within a larger online community. Categories of collection provided by the website 22, via the computer-readable medium 24 (shown in phantom) of the present invention that may be loaded into the website 22 or computing devices 12, 14, 16 or 18, can be based on any self-identified characteristic listed in the users' personal information page (e.g., university, gender, academic major, and race). Users can enter a particular collection, by selecting a specific collection group from a drop down menu of options, and thereby creating a sub-website comprised of only users with the specified characteristic.

The collection provided by the present invention, to be further discussed hereinafter, enhances the social-networking and online community experience by giving users 12, 14, 16 or 18 the power to specify the types of user that he/she desires to interact with. In particular, collection provided by the present invention, simplifies the process of meeting specific people by eliminating the need for a user to peruse other user's profile, or search the user database to determine which users possess certain characteristics. Accordingly, collection provided by the present invention facilitates interactions between people of specific characteristic, interest, lifestyle, and taste, and removes the clutter of irrelevant information. In addition, collection provided by the present invention eliminates the need for specified social-networking or traditional online community sites. The method of the present invention may be further described with reference to FIG. 2.

FIG. 2 is an overall flow diagram of a method 26 to enable and facilitate a website so as to provide networking for people having common interests or characteristics that may be shared by the users of the website 22. The method comprising the steps of: a) providing a website having a center for receiving information, such as 22 of FIG. 1. The method 26 needs at least one member of the website 22 to contact the website as shown in element 28 of FIG. 2. The at least one member provides, as shown in element 30 of FIG. 2, self-identified characteristics to the center of the website 22. The website 22 provides, as shown in element 32, a collection based on the member's self-identified characteristics and displayed on the computing device 12, 14, 16 or 18 of FIG. 1. The member then selects, as shown in element 34, the collection provided by website 22.

In general, the system 10 of FIG. 1 and method 26 of FIG. 2, as well as the computer-readable medium 24, shown in FIG. 1, of the present invention categorizes members or users into collections based on a database of users' personal information such as race, university, geographic region, sexual orientation, musical preference, etc. The personal information provided by the user determines the user's inclusion into any collection category. Further details of the method 26 of the present invention may be described with reference to FIG. 3, which is a flow diagram showing elements 36, 38 and 40, as well as element 34 of FIG. 2.

As seen in element 36 of FIG. 3, members or users are asked to input personal information when they first sign up as members of the website 22. Users are able to choose from a pre-designated list of categories for information that may be generalized (e.g., race, gender, and age), while being asked to type in specific information in categories that may result in a variety of answers (e.g., favorite music, favorite books, and extracurricular activities) with the system 10 capable of deciphering the information and allocating this information into the appropriate preset categories. Another way to decipher the characteristic of the user signing up on the website 22 is through the information the users provide that may not be part of the personal page, to be further described. For example, emails of the users that end in @columbia.edu would tell the system of the present invention that this user is associated with Columbia University, and without the user entering this information in his/her personal page, the practice of the present invention may automatically assume this user is a member of the “Columbia University,” “New York City,” “Ivy League” collections. The system of the present invention may also use other available methods, known in the art, to decipher information regarding the user who is signing up on the website 22. Preferably, there is no verification process involved with any self-identified categories, for the reasons that it would be almost impossible to accurately verify the information. The present invention provides users a forum to identify themselves based on their own self-constructed conceptions. Additionally, excluding user name and an email contact, users are not required to enter any other personal information, giving members the ability to provide as much or as little personal data as they see fit. Once the user becomes a member, the user may, at any time, modify or add personal information via their “Personal” page provided by the website 22 and displayed on the computing device 12, 14, 16 or 18. When the user modifies or enters additional information, the system 10 automatically updates the method 26 of the present invention to include/exclude the member from the appropriate collection categories.

All users entering the website 22 first log onto the main web page of website 22 displayed on the computer device 12, 14, 16 or 18, which includes all site members regardless of differences in users' personal information database. The main website is essentially some variation of the social-networking/online community model described in the “Background” section herein. Specifically, the website 22 may include, all known in the art, social interaction tools such as journal weblog, photo gallery, news, text messaging, file sharing, dating, and other mediums of social idea exchange. The websites 22 main homepage displays all these functions with a collage of postings/artworks by various users chosen based on the popularity of their expression. For example, the main homepage of website 22 showcases “Hot Journals” featuring the most read journal entries contributed by individual users.

In addition to the main homepage of website 22, each user, as shown in element 38, preferably has an individual homepage displaying these functions on computing device 12, 14, 16 or 18 with their personal information. From their individual homepage, members may display, on their computing device 12, 14, 16 or 18, pictures, post journal entry, send a message, and make use of the site's functions. Any member may access any other users' individual homepage, though they may only modify their own.

The website 22, as shown by element 40, provides a pre-list of collection categories. To enter a collection, users are asked to choose, as shown in element 34 of FIGS. 2 and 3 from the pre-set list of collection categories listed in a drop-down menu. Specific categories of collection are determined by the website administrators running the website 22, based on a variety of considerations including, but not limited to, total number of users who self-identified with the category, its viability as an identifying characteristic, and total number of user requests for the collection. Specifically regarding user requests, any member may suggest a new collection via a Collection Request provided by website 22; the weight/significance of user requests for a specific collection is proportional to the total number of requests made. The ultimate power to add new collection rests with website administrators handling website 22 to avoid the possibility of having redundant, inappropriate, and/or too many collection categories.

Once a member enters a collection, the features of the website are automatically readjusted to reflect the new restricted membership; for example, the Hot Journals section regroups to reflect only journals submitted by users who are members of the particular collection. Accordingly, within any collection, the member is assured that he/she is browsing and interacting with only users who are self-identified members of the collection. By entering a collection, users are essentially entering a community that operates in the same manner as a specified social-networking site, although with collection, they maintain immediate access to generic social-networking web content, as well as any number of other specified social-networking communities.

For example, an Asian American female attending Columbia University is a member of collections such as Columbia University, New York City, Asian American, women, and Ivy League; accordingly, her profile and postings show up when another member enters any of the previously mentioned collections. She may, in turn, choose to enter any collection, even if she is not a member of the group to view the information in that collection. The Collection feature enables users to group and re-group themselves into infinite sub-communities without the user ever leaving the overall social-networking/online community.

For the example given above, it may be appreciated that the collection of the present invention truly enhances the online community experience by allowing users the freedom to broaden or limit the scope of users they interact with. The practice of the present invention provides all the advantages of a specified site, while maintaining all the benefits of a generic online community. The practice of the present invention, e.g., the collection therefore, divides an overall online community into specialized, specified, and regionalized sub-communities serving particular needs and interests, and provides the mechanism for users to freely enter or exit these sub-communities.

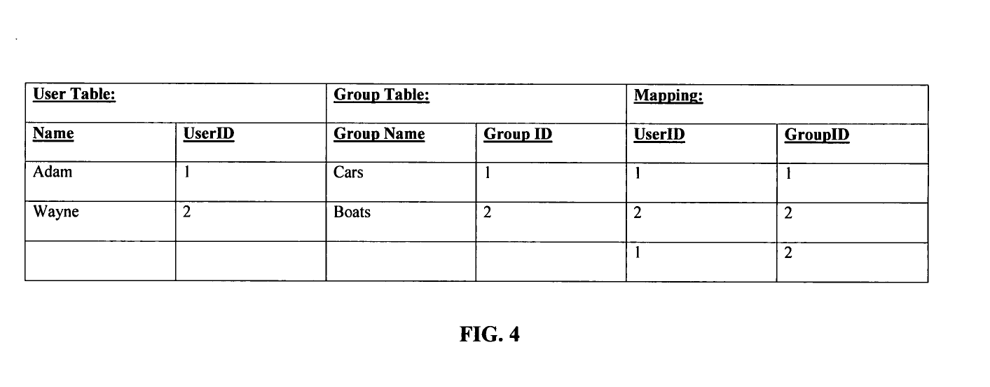

The collection mechanism, which is of particular importance to the present invention, comprises three separate tables in a database, one storing the members of the website 22, one storing the groups, and a third storing the mappings between the members and the groups. An example of a database is provided in FIG. 4.

For the example shown in FIG. 4, the practice of the present invention indicates that Adam is in group Cars as well as group Boats, while Wayne is only in group Boats. This data is retrieved from the database in a single query, calculating the union of the three tables to determine who is in what group.

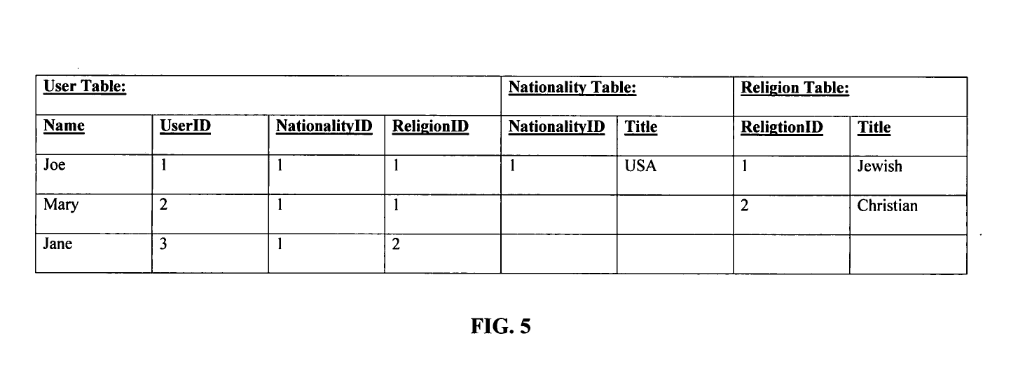

A second part of the collection mechanism performed by the practice of the present invention automatically associates users with groups based on certain information supplied by the user. An example of such grouping is provided in FIG. 5.

For the example shown in FIG. 5, the practice of the present invention causes the group to be formed by automatically finding commonalties between the users (a common NationalityID or ReligionID). Instead of the user creating a group, a group is automatically created by the practice of the present invention around a collection of users.

It is desired that the practice of the present invention use relational database software. A query for the transaction shown in FIG. 5 involving IDs is given below:

SELECT*

FROM users u, nationalities n

WHERE u nationality ID=n.nationalityID
AND n.nationality_id={SOME COMMONALITY}

The computer-readable medium 24, shown in FIG. 1 as being loadable into website 22 or any of the computing devices 12, 14, 16 or 18, has thereon computer-readable instructions that provide website 22 with networking capability for people having common interests or characteristics. The computer-readable instructions provide the center of the website 22 with the capability to receive information from at least one of the persons indicative of self-identified characteristics. The computer-readable instruction on the computer readable medium 24 also provide the website with a collection based on the persons' self-identified characteristics and present the collection so as to be selectable by the persons. Most importantly, the computer-readable instruction provides the networking for people having common interests or characteristics in response to the selection by the person in a manner as previously described.

It should now be appreciated that the practice of the present invention provides a system 10 and method 26, as well as computer-readable medium 24, generating collection subgroups within a main website that enable and facilitate social-networking for people having specific common interests or characteristics. Personal information provided by a user determines the users' automatic inclusion into a specific collection/category website. Computer generated routines supplied by the computer-readable medium of the present invention automatically fits users into a collection based on self-constructed concepts. Grouping users into a collection contained in the website allows dynamic social-networking without the need for a user to peruse others' profiles to identify common interests or characteristics.

It should be further appreciated that the collection feature of the present invention is not limited to the database of “Personal Information.” Collection may include any keyword on users' homepage. For example, a user may enter a collection of “Madonna,” which would create an online community of users who listed Madonna as a favorite artist. Under this collection mechanism, the website 22 will automatically cull through each user's homepage to extract and assign information into the appropriate collection category. The feature of collection of the present invention, therefore, is any means to create specified sub-communities within a larger social-networking website.

It should be still further appreciated that the collection of the present invention is not limited to “social-networking” websites. Instead, collection describes the mechanism to group and regroup an online collection of people based on a set of self-identified criteria. Collection may apply to social-networking sites, weblog sites, online directory sites, dating sites, and any other form of online communities that users may use as a means to meet other users.

While the invention has been particularly shown and described with reference to preferred embodiments thereof, it will be understood by those skilled in the art that the foregoing and other changes in form and details may be made therein without departing from the spirit and scope of the invention.

What we claim is:

1. A method to enable and facilitate a website to provide networking, said method comprising the steps of:
a) providing a website having a center for receiving information;
b) providing at least one member of said website;
c) said at least one member providing self-identified characteristics to said center of said website;
d) said website providing at least one collection based on said member's self-identified characteristics; and
e) said member selecting one of said collections.

2. The method according to claim 1, wherein said website is selectable from a group of sites consisting of a social-network, a traditional online community, weblog, online directory, and dating.

3. The method according to claim 1, wherein said self-identified characteristics of said member is selectable from a list of collection categories provided by said website consisting of race, gender, age, geographic region, sexual orientation, musical preference, university, and academic major.

4. The method according to claim 1, wherein said website comprises a homepage having social interaction tools selectable from the group of routines comprising journal weblog, photo gallery, news, text messaging, file sharing and dating.

5. A method to enable and facilitate a website to provide networking, said method comprising the steps of:
a) providing a website having a center for receiving information;
b) providing at least two members of said website;
c) each of said at least two members providing self-identified characteristics to said center of said website;
d) said website providing at least one collection based on said at least two members' common self-identified characteristics; and
e) each of said at least two members selecting one of said collections.

6. A system to enable and facilitate a website to provide networking comprising:
a) a website having a center for receiving information;
b) at least one member of said website providing self-identified characteristics to said center of said website;
c) said website having a database providing at least one collection based on said member's self-identified characteristics; and
d) said website having means so as to allow said member to select one of said collections.

7. The system according to claim 6, wherein said website is selectable from a group of sites consisting of a social-network, a traditional online community, weblog, online directory, and dating.

8. The system according to claim 6, wherein said self-identified characteristics of said member is selectable from a list of collection categories provided by said website consisting of race, gender, age, geographic region, sexual orientation, musical preference, university, and academic major.

9. The system according to claim 6, wherein said website comprises a homepage having social interaction tools selectable from the group of routines consisting of journal weblog, photo gallery, news, text messaging, file sharing and dating.

10. The system according to claim 6, wherein said database providing said at least one collection comprises three tables, the first of which stores the identity of the members of said website, the second of which stores groups comprising said collection, and the third of which stores the mapping between the first and second tables.

11. A system to enable and facilitate a website to provide networking comprising:
a) a website having a center for receiving information;
b) at least two members of said website providing self-identified characteristics to said center of said website;
c) said website having a database providing at least one collection based on said at least two members' common self-identified characteristics; and
d) said website having means so as to allow each of said at least two members to select one of said collections.

12. A computer-readable medium having thereon computer-readable instructions for providing a website with networking capability, said website having a center for receiving information, said computer-readable instructions comprising:
providing said center with the capability to receiving information from at least one person and which information is indicative of self-identified characteristics of said person;
providing said website with at least one collection based on said person's self-identified characteristics;
presenting said at least one collection so as to be selectable by said person; and
providing said networking for people having common interests or characteristics in response to said selection by said person.

13. The computer-readable medium according to claim 12, wherein said website is selectable from a group of sites consisting of a social-network, traditional online community, weblog, online directory, and dating.

14. The computer-readable medium according to claim 12, wherein said self-identified characteristics of said member is selectable from a list of collection categories provided by said computer-readable medium consisting of race, gender, age, geographic region, sexual orientation, musical preference, university, and academic major.

15. The computer-readable medium according to claim 12, further having a routine for a homepage having social interaction tools, wherein said computer-readable instructions further comprising providing said routines selectable from the group consisting of journal weblog, photo gallery, news, text messaging, file sharing and dating.

16. The computer-readable medium according to claim 12, further having a database, wherein said computer-readable instructions further comprising providing said at least one collection with three tables, the first of which stores the identity of the members of said website, the second of which stores groups, and the third of which comprises mapping between the first and second tables.
